(19) United States
(12) Patent Application Publication
(10) Pub. No.: US 2026/0251230 A1
(43) Pub. Date: Aug. 27, 2026

(54) PRESSURE RELIEF VALVE

(71) Applicant: NIFCO INC., Yokosuka-shi, Kanagawa (JP)

(72) Inventor: Ryoya OKUMA, Yokosuka-shi, Kanagawa (JP)

(21) Appl. No.: 19/158,044

(22) PCT Filed: Mar. 18, 2024
(86) PCT No.: PCT/JP2024/010519

§ 371 Date: Aug. 20, 2025

(30) Foreign Application Priority Data
Apr. 12, 2023 (JP) 2023-065217

(51) Int. Cl. F16K 17/04; A62C 3/16

(52) U.S. Cl. CPC F16K 17/0413; A62C 3/16

(57) ABSTRACT

A pressure relief valve includes a base part fixed to a surface of an enclosure, a valve member including a roof, a filled member positioned between the base part and the valve member and filled with a fire extinguishing agent, and a point member to release the fire extinguishing agent from the filled member. The valve member is in a closed position when the internal pressure of the fluid is below a threshold, and in an open position when the internal pressure of the fluid exceeds the threshold. The valve member closes the opening when the valve member is in the closed position, and opens the opening when the valve member is in the open position. The starting point member releases the fire extinguishing agent from the filled member when the valve member moves from the open position to the closed position.

### FIELD

The present invention relates to a pressure relief valve that regulates pressure inside an enclosure.

### BACKGROUND

A pressure relief valve is a device for regulating pressure inside an enclosure. The enclosure is, for example, a battery pack mounted in a vehicle. Inside the battery pack, a device, such as a battery cell, is accommodated and sealed.

The pressure relief valve is attached to the enclosure, such as the battery pack. For example, the pressure relief valve is placed to cover an opening formed in the enclosure. If the pressure inside the enclosure exceeds a threshold, the pressure relief valve works in such a manner that a fluid inside the enclosure is released outside. The pressure relief valve can prevent damage to the device inside the enclosure due to a pressure rise. This improves the safety of the battery pack.

In a situation where the pressure inside the enclosure rises, there is a possibility that ignition occurs inside the enclosure. For fire extinction, for example, Patent Literature 1 proposes to install a breaking valve that breaks when the pressure rises, in a pressure relief valve. The breaking valve is filled with a fire extinguishing agent. If the breaking valve breaks, the fire extinguishing agent is released. As another example, Patent Literature 2 proposes a fire suppression apparatus including a detection sensor detecting fire in a battery pack and a storage tank storing a fire extinguishing agent. If fire is detected, the fire extinguishing agent is poured into the battery pack from an outlet valve. The battery pack includes a discharge valve allowing gas generated inside to be emitted.

### CITATION LIST

### Patent Literature

Patent Literature 1: Japanese Patent Application Laid-open No. 2020-55587
Patent Literature 2: Japanese Patent No. 6132289

### SUMMARY OF THE INVENTION

In Patent Literature 1, while gas inside an enclosure is escaping, the fire extinguishing agent is released to the inside of the enclosure. If the inside and outside of the enclosure communicate, there is a possibility that oxygen from outside the enclosure flows inside the enclosure. If oxygen flows inside the enclosure, time required for fire extinction increases, and an amount of the fire extinguishing agent required for the fire extinction also increases. The fire suppression apparatus in Patent Literature 2 requires high cost.

An object of the present invention is to provide a pressure relief valve that can solve these problems.

The present invention relates to the following [1] to [6].
[1] A pressure relief valve configured to, upon a rise in an internal pressure of a fluid inside an enclosure, allow the fluid to escape from an opening of the enclosure, the pressure relief valve including:
a base part fixed to a surface of the enclosure so as to partially overlap the opening of the enclosure;
a valve member including a roof capable of covering the opening, the valve member being movable to open the opening;
a filled member positioned between the base part and the valve member, the filled member being filled with a fire extinguishing agent; and
a starting point member configured to release the fire extinguishing agent from the filled member, wherein
the valve member is configured to be in a closed position when the internal pressure of the fluid is below a threshold, and the valve member is configured to be in an open position when the internal pressure of the fluid exceeds the threshold,
the valve member is configured to close the opening when the valve member is in the closed position,
the valve member is configured to open the opening when in the open position, and
the starting point member is configured to release the fire extinguishing agent from the filled member when the valve member moves from the open position to the closed position.
[2] In the pressure relief valve described in [1], the starting point member may be attached to the valve member.
[3] In the pressure relief valve described in [1] or [2], the valve member may move from a first closed position to the open position when the internal pressure of the fluid increases, and then, move from the open position to a second closed position when the internal pressure of the fluid decreases. The valve member closes the opening when the valve member is in the first closed position and in the second closed position. The starting point member may release the fire extinguishing agent from the filled member when the valve member is in the second closed position.
[4] In the pressure relief valve described in [3], the filled member may include the fire extinguishing agent, a container accommodating the fire extinguishing agent, and a film sealing the container, and the starting point member may include a sharp structure piercing the film when the valve member is in the second closed position.
[5] In the pressure relief valve described in [4], the filled member may include a standby portion preventing contact with the starting point member when the valve member is in the first closed position.
[6] In the pressure relief valve described in any one of [3] to [5], the valve member may include a shaft extending downward from the roof, and the pressure relief valve may include a cam structure differentiating, in a peripheral direction with the shaft as a center, a position of the valve member in the peripheral direction in the first closed position from a position of the valve member in the peripheral direction in the second closed position.

According to the present invention, the pressure relief valve that can efficiently digest fire inside the enclosure can be provided at low cost.

### BRIEF DESCRIPTION OF DRAWINGS

FIG. 1 is a perspective view illustrating an example of a pressure relief valve attached to an enclosure.

FIG. 2 is a plan view illustrating an example of an enclosure.

FIG. 3 is an exploded view illustrating the example of the pressure relief valve.

FIG. 4A is a plan view illustrating an example of the pressure relief valve in a first closed state.

FIG. 4B is a sectional view illustrating the example of the pressure relief valve in the first closed state.

FIG. 5A is a perspective view illustrating an example of the valve member.

FIG. 5B is a perspective view illustrating an example of a starting point member.

FIG. 6 is a perspective view illustrating an example of a filled member.

FIG. 7A is a plan view illustrating an example of the pressure relief valve in an open state.

FIG. 7B is a sectional view illustrating the example of the pressure relief valve in the open state.

FIG. 8A is a plan view illustrating an example of the pressure relief valve in a second closed state.

FIG. 8B is a sectional view illustrating the example of the pressure relief valve in the second closed state.

FIG. 9A is a perspective view illustrating a positional relationship between the filled member and the starting point member in the first closed state.

FIG. 9B is a perspective view illustrating a positional relationship between the filled member and the starting point member in the open state.

FIG. 9C is a perspective view illustrating a positional relationship between the filled member and the starting point member in the second closed state.

FIG. 10 is a rear view illustrating an example of a base part and an end lock.

FIG. 11 is a rear view illustrating the example of the end lock.

FIG. 12 is a perspective view illustrating an example of a first groove of the base part.

### DESCRIPTION OF EMBODIMENTS

An embodiment of the present invention will be described with reference to the drawings. In the drawings attached to this specification, for convenience of facilitation of understanding, the scale, the ratio of lengthwise and breadthwise dimensions, and the like are changed and exaggerated from actual ones as appropriate.

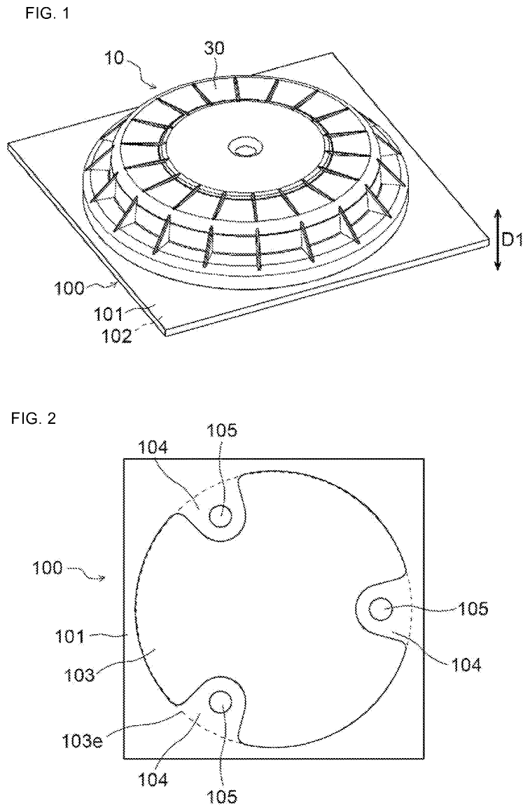

FIG. 1 is a perspective view illustrating an example of a pressure relief valve 10. The pressure relief valve 10 is attached to a surface of an enclosure 100. The enclosure 100 is, for example, a battery pack mounted in a vehicle. Inside the battery pack, a device, such as a battery cell, is accommodated and sealed. The enclosure 100 includes a surface 101 and a rear surface 102. The surface 101 is in contact with an atmosphere outside the enclosure 100. The rear surface 102 is in contact with an interior space sealed by the enclosure 100.

If pressure inside the enclosure 100 exceeds a threshold, the pressure relief valve 10 works in such a manner that a fluid, such as gas, inside the enclosure 100 is released outside. The pressure inside the enclosure 100 is also referred to as an internal pressure.

FIG. 2 is a plan view illustrating the enclosure 100 without the pressure relief valve 10 attached. The enclosure 100 includes an opening 103 penetrating the enclosure 100. The pressure relief valve 10 is attached to the enclosure 100 so as to cover the opening 103. The pressure relief valve 10 is positioned above the surface 101 of the enclosure 100.

The opening 103 may include an outer edge having a substantially circular shape in a plan view. The reference sign 103e indicates an envelope circle of the opening 103. The envelope circle 103e is composed of a circular line enveloping the outer edge of the opening 103 in a plan view. The plan view indicates that an object is viewed along the normal direction of the surface 101 of the enclosure 100.

The enclosure 100 may include a plurality of protrusions 104 that is in contact with the opening 103 and that protrudes from the envelope circle 103e toward the center of the opening 103. For example, the enclosure 100 may include three protrusions 104. The protrusions 104 may be arranged at regular intervals along the circumferential direction of the envelope circle 103e. In the protrusions 104, fastening holes 105 into which fastening tools are inserted are formed. The fastening holes 105 are positioned on the inner side relative to the envelope circle 103e.

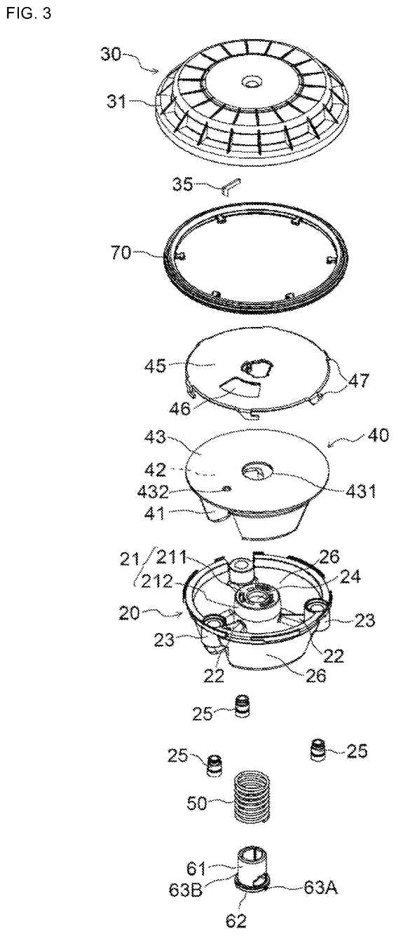

FIG. 3 is an exploded view illustrating the pressure relief valve 10. The pressure relief valve 10 includes at least a base part 20, a valve member 30, a starting point member 35, and a filled member 40. The pressure relief valve 10 may further include an elastic member 50, an end lock 60, a seal member 70, and the like.

While the enclosure 100, such as the battery pack, is operating normally, the opening 103 of the enclosure 100 is closed by the valve member 30. This state is also referred to as a first closed state. The position of the valve member 30 in the first closed state is also referred to as a first closed position.

If the pressure inside the enclosure 100 increases and the pressure exceeds a threshold, the valve member 30 moves from the first closed position to an open position. This opens the opening 103 of the enclosure 100 and allows the fluid, such as gas, inside the enclosure 100 to be released outside. The state in which the valve member 30 is in the open position is also referred to as an open state.

If the fluid is released outside, the pressure inside the enclosure 100 decreases. If the pressure falls below the threshold, the valve member 30 moves from the open position to a second closed position. This allows the opening 103 of the enclosure 100 to be closed again by the valve member 30. This state is also referred to as a second closed state.

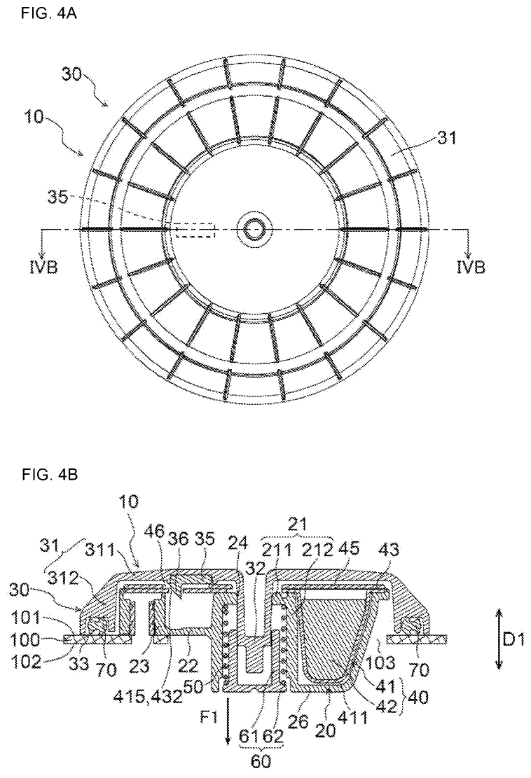

Each constituent of the pressure relief valve 10 will be described. FIG. 4A is a plan view illustrating an example of the pressure relief valve 10 in the first closed state. FIG. 4B is a sectional view of the pressure relief valve 10 in FIG. 4A, taken along a line IVB-IVB.

### Base Part

The base part 20 is fixed to the enclosure 100 so as to partially overlap the opening 103 of the enclosure 100. As illustrated in FIG. 3, the base part 20 may include a housing 21, legs 22, and fastened portions 23.

As illustrated in FIGS. 3 and 4B, the housing 21 includes an upper portion 211 overlapping the opening 103 of the enclosure 100 in a plan view and a side portion 212 expanding downward from the upper portion 211. The upper portion 211 may have a circular shape in a plan view. In the upper portion 211 of the housing 21, a central opening 24 penetrating the upper portion 211 may be formed.

The legs 22 are coupled to the side portion 212 of the housing 21. The legs 22 extend outward from the housing 21 in a plan view. The legs 22 include ends overlapping the surface 101 of the enclosure 100 in a plan view. The base part 20 may include a plurality of the legs 22. For example, the base part 20 may include three legs 22. The legs 22 may be arranged at regular intervals along the peripheral direction of the housing 21.

The fastened portions 23 may be formed at the legs 22. The fastened portions 23 are portions of the base part 20 that are fastened to the enclosure 100. The fastened portions 23 are, for example, holes into which fastening tools 25 illustrated in FIG. 3 are inserted. The fastening tools 25 are, for example, bolts. By inserting the fastening tools 25 into the fastened portions 23 of the base part 20 and the fastening holes 105 of the enclosure 100 and fixing the fastening tools 25 with nuts or the like, the base part 20 is fixed to the enclosure 100.

The base part 20 may include accommodating portions 26 where the filled member 40 is accommodated. The accommodating portions 26 may expand between two legs 22 adjacent to each other in the peripheral direction of the pressure relief valve 10. The base part 20 may include a plurality of the accommodating portions 26. For example, the base part 20 may include three legs 22 and three accommodating portions 26.

### Valve Member

The valve member 30 includes at least a roof 31 that can cover the opening in a plan view. The roof 31 can move in a first direction D1 in accordance with the internal pressure. The first direction D1 is a normal direction of the surface 101 of the enclosure 100.

As illustrated in FIG. 4B, the roof 31 includes an upper portion 311 covering the opening 103 of the enclosure 100 in a plan view and a side portion 312 expanding from the upper portion 311 toward the enclosure 100. The upper portion 311 may have a circular shape in a plan view. The side portion 312 may have a tube shape.

As illustrated in FIG. 4B, a groove 33 may be formed in a bottom surface of the side portion 312 of the roof 31. The seal member 70 may be disposed in the groove 33. The seal member 70 is, for example, a gasket. The seal member 70 surrounds the opening 103 of the enclosure 100 in a plan view. In the first closed state and the second closed state, the seal member 70 is in contact with the roof 31 of the valve member 30 and the surface 101 of the enclosure 100. Thus, the opening 103 is closed.

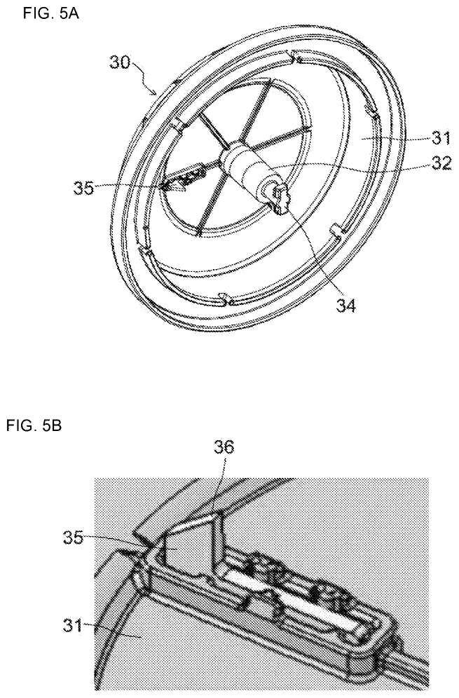

FIG. 5A is a perspective view illustrating an example of the valve member 30. The valve member 30 may include a shaft 32 extending downward from the center of the roof 31 along the first direction D1. At a lower end of the shaft 32, an engaging portion 34 to be coupled to the end lock 60 may be formed. The shaft 32 extends linearly from the roof 31 toward the opening 103. As illustrated in FIG. 4B, the shaft 32 is inserted into the central opening 24 of the base part 20.

As illustrated in FIG. 4B, the end lock 60 may be coupled to the shaft 32. The end lock 60 includes, for example, a side portion 61 and a lower portion 62 coupled to the side portion 61 and positioned below the side portion 61 and the shaft 32. The side portion 61 surrounds the shaft 32 in a plan view. The side portion 61 may be fixed to the shaft 32. “Downward” indicates a direction from the roof 31 toward the surface 101 in the first direction D1. “Upward” indicates a direction from the surface 101 toward the roof 31 in the first direction D1.

### Elastic Member

The elastic member 50 urges the valve member 30 toward the enclosure 100 in the first direction D1. The elastic member 50 expands and contracts in the first direction D1 in accordance with movement of the valve member 30 in the first direction D1. The elastic member 50 is, for example, a coil spring.

The elastic member 50 includes an upper end and a lower end. The upper end of the elastic member 50 is in contact with the base part 20. For example, the upper end of the elastic member 50 is in contact with the upper portion 211 of the housing 21 of the base part 20. The lower end of the elastic member 50 is in contact with the lower portion 62 of the end lock 60. The shaft 32 of the valve member 30 is inserted inside the elastic member 50.

### Filled Member

The filled member 40 is positioned between the base part 20 and the roof 31 of the valve member 30 in the first direction D1. The filled member 40 includes at least a sealed fire extinguishing agent 42.

When the pressure relief valve 10 is in the first closed state and in the open state, the fire extinguishing agent 42 is sealed. When the pressure relief valve 10 is in the second closed state, sealing of the fire extinguishing agent 42 is broken by the starting point member 35. This releases the fire extinguishing agent 42 from the filled member 40.

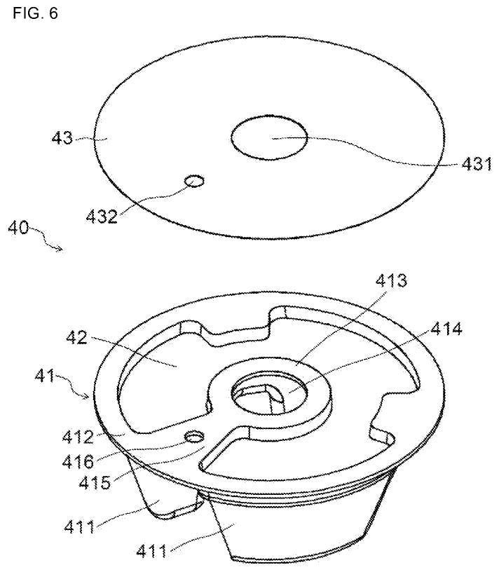

FIG. 6 is a perspective view illustrating an example of the filled member 40. The filled member 40 may include the fire extinguishing agent 42, a container 41 accommodating the fire extinguishing agent 42, and a film 43 sealing the container 41.

The container 41 includes, for example, an accommodating portion 411, an outer rim 412, and an inner rim 413. The accommodating portion 411 accommodates the fire extinguishing agent 42. The outer rim 412 expands from an outer portion of an upper end of the accommodating portion 411 in the horizontal direction. The horizontal direction is a direction orthogonal to the first direction D1. “Outer” indicates a direction away from the center of the pressure relief valve 10 in a plan view. The outer rim 412 may have a circular contour in a plan view. The inner rim 413 expands from an inner portion of the upper end of the accommodating portion 411 in the horizontal direction. “Inner” indicates a direction toward the center of the pressure relief valve 10 in a plan view. The outer rim 412 and the inner rim 413 compose a top surface of the container 41. The film 43 is bonded to the top surface of the container 41.

A central opening 414 may be formed in the inner rim 413. Similarly, a central opening 431 may be formed in the film 43. The shaft 32 of the valve member 30 is inserted into the central opening 414 and the central opening 431.

The container 41 may include a coupled portion 415 extending from the outer rim 412 to the inner rim 413 in the horizontal direction. The container 41 may include a through hole 416 penetrating the coupled portion 415. Similarly, the film 43 may include a through hole 432 overlapping the through hole 416 in a plan view. In the first closed state, a tip of the starting point member 35 is inserted into the through hole 416 and the through hole 432.

The through hole 416 and the through hole 432 function as a standby portion where the starting point member 35 is positioned when the pressure relief valve 10 is in the first closed state. The standby portion is a constituent for enabling a state in which the starting point member 35 is not in contact with the filled member 40. The specific structure of the standby portion is not limited to a through hole. The standby portion may be a notch, a slit, a groove, or the like, which is not illustrated in the drawings.

### Cover

The cover 45 is covered over the film 43 of the filled member 40. As illustrated in FIG. 3, in the cover 45, a through hole 46 penetrating the cover 45 may be formed. The through hole 46 overlaps the through hole 432 of the film 43 in a plan view. The through hole 46 may be configured so that the starting point member 35 is not in contact with the cover 45 when the pressure relief valve 10 is in the first closed state and in the second closed state.

The cover 45 may include a plurality of claws 47 positioned at an outer edge of the cover 45. By hooking the claws 47 on the outer rim 412 of the container 41, the cover 45 is fixed to the container 41.

### Starting Point Member

The starting point member 35 is a member for releasing the fire extinguishing agent 42 from the filled member 40 when the pressure relief valve 10 is in the second closed state. As illustrated in FIG. 5A, the starting point member 35 may be attached to a bottom surface of the roof 31 of the valve member 30.

FIG. 5B is a perspective view illustrating an example of the starting point member 35. The starting point member 35 has a sharp structure that pierces the film 43 of the filled member 40. For example, the starting point member 35 includes a sharp tip 36 protruding downward.

Next, operation of the pressure relief valve 10 will be described.

As illustrated in FIG. 4B, when the valve member 30 is in the first closed position, the tip 36 of the starting point member 35 is inserted into the through hole 416 of the container 41, the through hole 432 of the film 43, and the through hole 46 of the cover 45. That is, the tip 36 of the starting point member 35 is positioned in the standby portion.

When the valve member 30 is in the first closed position, the elastic member 50 generates urging force F1 urging the valve member 30 toward the enclosure 100. For example, the elastic member 50 is in a contracting state. Thus, restoring force is generated in the elastic member 50. The elastic member 50 presses the lower portion 62 of the end lock 60 downward, so that the valve member 30 is urged downward. Thus, the seal member 70 attached to the valve member 30 comes into contact with the surface 101 of the enclosure 100. This seals the interior space of the enclosure 100.

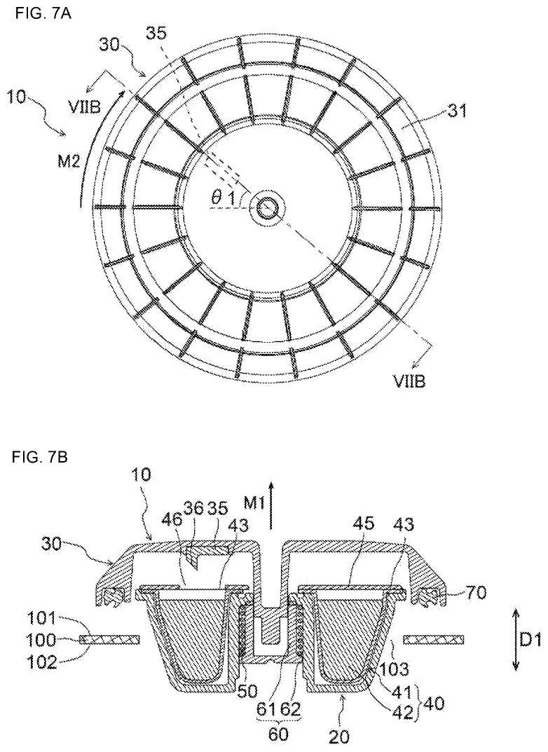

FIG. 7A is a plan view illustrating an example of the pressure relief valve 10 in the open state. FIG. 7B is a sectional view of the pressure relief valve 10 in FIG. 7A, taken along a line VIIB-VIIB. If the internal pressure of the enclosure 100 exceeds the threshold, force applied by the internal pressure to the valve member 30 is greater than the urging force F1 applied by the elastic member 50 to the valve member 30. As a result, as illustrated with the arrow M1 in FIG. 7B, the valve member 30 moves upward. The valve member 30 moves upward until the force applied by the internal pressure to the valve member 30 balances with the force applied by the elastic member 50 to the valve member 30. The starting point member 35, the end lock 60, and the seal member 70 also move upward together with the valve member 30. In the open state, the elastic member 50 contracts more than the elastic member 50 in the first closed state.

The pressure relief valve 10 includes a cam structure. The cam structure is for differentiating a position of the valve member 30 in the peripheral direction in the first closed position from a position of the valve member 30 in the peripheral direction in the second closed position in the peripheral direction with the shaft 32 of the valve member 30 as the center. The cam structure may differentiate the position of the valve member 30 in the peripheral direction in the first closed position from a position of the valve member 30 in the peripheral direction in the open position in the peripheral direction with the shaft 32 of the valve member 30 as the center. For example, as illustrated with the arrow M2 in the peripheral direction in FIG. 7A, while the valve member 30 moves upward in the first direction D1, the valve member 30 may rotate clockwise by an angle θ1 in the peripheral direction. This also changes a position, in the peripheral direction, of the starting point member 35 attached to the valve member 30. For example, as illustrated in FIG. 7B, the starting point member 35 moves to a position where the tip 36 of the starting point member 35 overlaps the film 43 in a plan view.

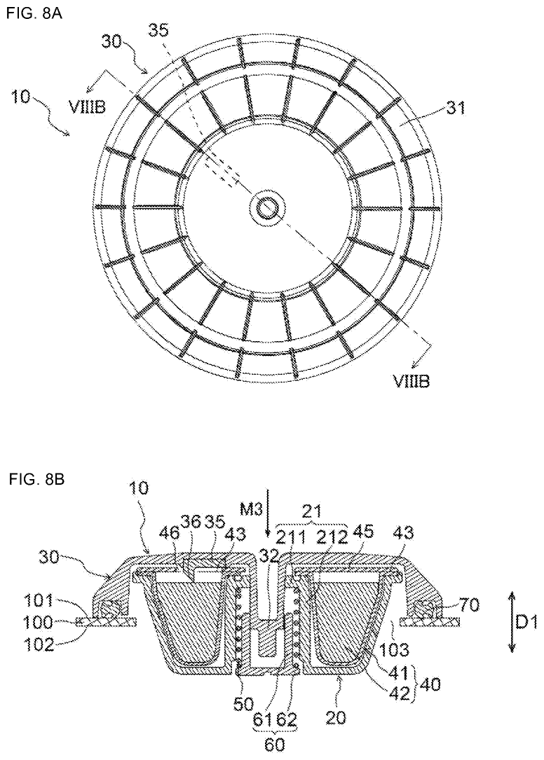

As the fluid is released outside, the internal pressure decreases. If the force applied by the internal pressure to the valve member 30 is smaller than the force applied by the elastic member 50 to the valve member 30, the restoring force of the elastic member 50 moves the valve member 30 downward, and the valve member 30 closes the opening 103 again. That is, as illustrated with the arrow M3 in FIG. 8B, the valve member 30 moves downward toward the second closed position. FIG. 8A is a plan view illustrating an example of the pressure relief valve 10 in the second closed state. FIG. 8B is a sectional view of the pressure relief valve 10 in FIG. 8A, taken along a line VIIIB-VIIIB. As illustrated in FIG. 8A, while the valve member 30 moves from the open position to the second closed position, movement of the valve member 30 in the peripheral direction may not occur.

As illustrated in FIG. 8B, when the valve member 30 moves to the second closed position, the tip 36 of the starting point member 35 pierces the film 43 of the filled member 40, forming a pierced portion in the film 43. As a result, the interior of the container 41 of the filled member 40 communicates with the outside of the container 41 via the pierced portion of the film 43. If a rise in the internal pressure of the enclosure 100 is caused by fire that has occurred inside the enclosure 100, pressure inside the container 41 also rises. Thus, if the pierced portion is formed in the film 43, the fire extinguishing agent 42 inside the container 41 is released outside the container 41.

The fire extinguishing agent 42 released outside the container 41, for example, collides with the bottom surface of the roof 31, then falls by gravity, and enters the inside of the enclosure 100. This extinguishes the fire inside the enclosure 100.

In this embodiment, when the fire extinguishing agent 42 is released from the filled member 40, the pressure relief valve 10 is in the second closed state. This prevents oxygen outside the pressure relief valve 10 from flowing inside the enclosure 100. Furthermore, the fire extinguishing agent 42 is prevented from flowing outside the pressure relief valve 10. Thus, according to this embodiment, in comparison with a case where the fire extinguishing agent is released with the opening 103 of the enclosure 100 open, the time required for fire extinction can be shortened, and the amount of the fire extinguishing agent required for the fire extinguishing can be reduced. Furthermore, according to this embodiment, an expensive component, such as a detecting sensor for detecting fire, is unnecessary, so that the pressure relief valve 10 can be provided at a low cost.

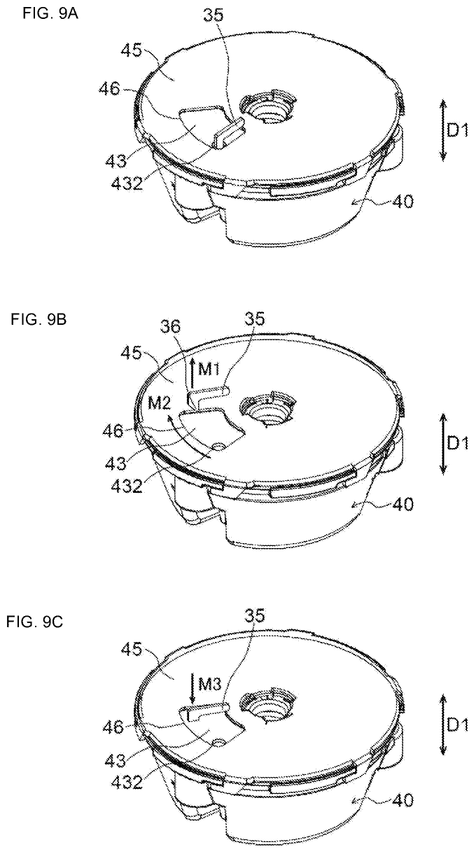

With reference to FIGS. 9A to 9C, positional relationships between the filled member 40 and the starting point member 35 will be described in detail.

FIG. 9A is a perspective view illustrating a positional relationship between the filled member 40 and the starting point member 35 in the first closed state. The starting point member 35 is inserted into the through hole 46 of the cover 45 and the through hole 432 of the film 43.

FIG. 9B is a perspective view illustrating a positional relationship between the filled member 40 and the starting point member 35 in the open state. In transition from the first closed state to the open state, the starting point member 35 moves upward in the first direction D1 as illustrated with the arrow M1 and moves in the peripheral direction as illustrated with the arrow M2.

FIG. 9C is a perspective view illustrating a positional relationship between the filled member 40 and the starting point member 35 in the second closed state. In transition from the open state to the second closed state, the starting point member 35 moves downward in the first direction Dl as illustrated with the arrow M3. As a result, the starting point member 35 sticks through the film 43.

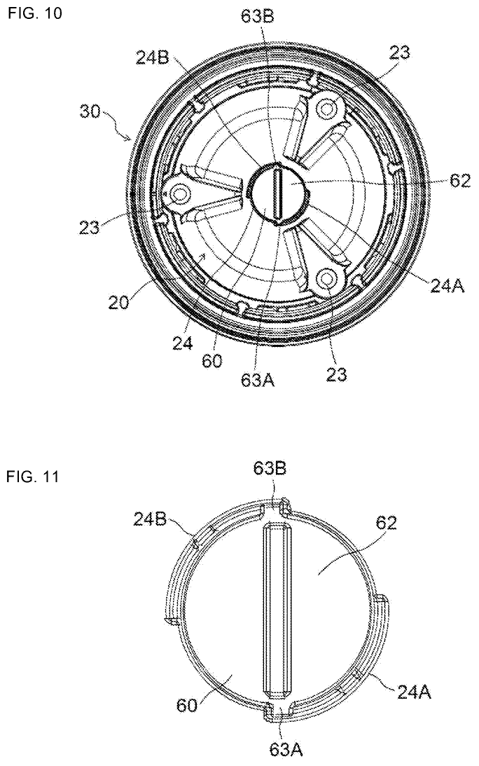

An example of the cam structure for enabling movement of the valve member 30, the starting point member 35, and the end lock 60 in the peripheral direction will be described with reference to FIGS. 10 to 12.

FIG. 10 is a rear view illustrating an example of the base part 20 and the end lock 60. The end lock 60 may include one or two or more juts protruding outward from the lower portion 62. For example, the end lock 60 may include a first jut 63A and a second jut 63B. The first jut 63A and the second jut 63B may be 180° apart in the peripheral direction. In the side portion 212 of the base part 20, grooves that faces the central opening 24 and where the juts of the end lock 60 can move may be formed. FIG. 11 is a rear view illustrating the juts of the end lock 60 and the grooves of the base part 20 in an enlarged manner. For example, the base part 20 may include a first groove 24A where the first jut 63A can move and a second groove 24B where the second jut 63B can move.

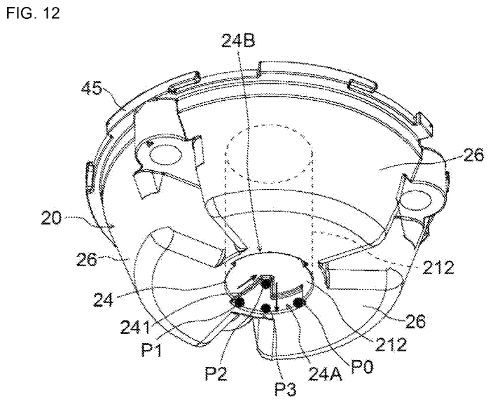

FIG. 12 is a perspective view illustrating an example of the first groove 24A of the base part 20. The first groove 24A may include a slope surface 241 displacing in the peripheral direction as it goes upward. The second groove 24B may also include a similar slope surface, which is not illustrated in the drawings.

In FIG. 12, the black dot with the reference sign P1 indicates a position of the first jut 63A in the first closed state. A black dot with the reference sign P2 indicates a position of the first jut 63A in the open state. In the transition from the first closed state to the open state, the end lock 60 moves upward together with the valve member 30. When the end lock 60 moves upward with the first jut 63A in contact with the slope surface 241, the end lock 60 receives force in the peripheral direction from the slope surface 241. As a result, in the transition from the first closed state to the open state, the end lock 60, the valve member 30, and the starting point member 35 can move in the peripheral direction.

In FIG. 12, a black dot with a reference sign P3 indicates a position of the first jut 63A in the second closed state. In the transition from the open state to the second closed state, the end lock 60 moves downward together with the valve member 30. The position P3 of the first jut 63A in the second closed state differs from the position P1 of the first jut 63A in the first closed state in the peripheral direction. In this way, the grooves of the base part 20 and the juts of the end lock 60 can function as the cam structure.

### Method of Manufacturing Pressure Relief Valve

An example method of manufacturing the pressure relief valve 10 will be described.

The starting point member 35 is attached to the valve member 30. Then, the seal member 70 is attached to the groove 33 of the valve member 30.

The fastening tools 25 are attached to the base part 20. Then, the filled member 40 is assembled to the base part 20. Then, the filled member 40 is covered with the cover 45. Then, the valve member 30 is assembled to the base part 20.

Then, the elastic member 50 is inserted into the central opening 24 of the base part 20. Then, the side portion 61 of the end lock 60 is inserted inside the elastic member 50. After the elastic member 50 is compressed with the end lock 60, the end lock 60 is rotated 90° in the peripheral direction. For example, the end lock 60 is rotated so that the first jut 63A of the end lock 60 moves from the position P0 to the position P1 in FIG. 12. This engages the end lock 60 with the engaging portion 34 of the valve member 30 and fixes the end lock 60 to the valve member 30. In this way, the pressure relief valve 10 is manufactured.

Various modifications can be made to the above-described embodiment.

### First Modification

In the above-described embodiment, it is exemplified that the starting point member 35 is a member separate from the valve member 30. The starting point member 35 may be a member integrated with the valve member 30, which is not illustrated in the drawings. For example, the roof 31 and the starting point member 35 may be formed integrally by resin molding.

### Second Modification

In the above-described embodiment, it is exemplified that the container 41 of the filled member 40 is a member separate from the accommodating portions 26 of the base part 20. The container 41 of the filled member 40 may be a member integrated with the accommodating portions 26 of the base part 20, which is not illustrated in the drawings.

### Third Modification

In the above-described embodiment, it is exemplified that power for moving the valve member 30 in the peripheral direction is enabled by the cam structure using the grooves of the base part 20 and the juts of the end lock 60. Power for moving the valve member 30 in the peripheral direction may be enabled by rotational force by a coil spring, which is not illustrated in the drawings.

### Other Modifications

A plurality of the modifications may be combined with the above-described embodiments.

### REFERENCE SIGNS LIST

10 Pressure relief valve
20 Base part
30 Valve member
31 Roof
32 Shaft
35 Starting point member
40 Filled member
41 Container
42 Fire extinguishing agent
43 Film
50 Elastic member
60 End lock
100 Enclosure

1. A pressure relief valve configured to, upon a rise in an internal pressure of a fluid inside an enclosure, allow the fluid to escape from an opening of the enclosure, the pressure relief valve comprising:
a base part fixed to a surface of the enclosure so as to partially overlap the opening of the enclosure;
a valve member including a roof capable of covering the opening, the valve member being movable to open the opening;
a filled member positioned between the base part and the valve member, the filled member being filled with a fire extinguishing agent; and
a starting point member configured to release the fire extinguishing agent from the filled member, wherein
the valve member is configured to be in a closed position when the internal pressure of the fluid is below a threshold, and the valve member is configured to be in an open position when the internal pressure of the fluid exceeds the threshold,
the valve member is configured to close the opening when the valve member is in the closed position,
the valve member is configured to open the opening when the valve member is in the open position, and
the starting point member is configured to release the fire extinguishing agent from the filled member when the valve member moves from the open position to the closed position.

2. The pressure relief valve according to claim 1, wherein the starting point member is attached to the valve member.

3. The pressure relief valve according to claim 1, wherein
the valve member is configured to move from a first closed position to the open position when the internal pressure of the fluid increases, and then, move from the open position to a second closed position when the internal pressure of the fluid decreases,
the valve member is configured to close the opening when the valve member is in the first closed position and in the second closed position, and
the starting point member is configured to release the fire extinguishing agent from the filled member when the valve member is in the second closed position.

4. The pressure relief valve according to claim 3, wherein
the filled member includes the fire extinguishing agent, a container accommodating the fire extinguishing agent, and a film sealing the container, and
the starting point member includes a sharp structure configured to pierce the film when the valve member is in the second closed position.

5. The pressure relief valve according to claim 4, wherein the filled member includes a standby portion configured to prevent contact with the starting point member when the valve member is in the first closed position.

6. The pressure relief valve according to claim 3, wherein
the valve member includes a shaft extending downward from the roof, and
the pressure relief valve includes a cam structure configured to differentiate, in a peripheral direction with the shaft as a center, a position of the valve member in the peripheral direction in the first closed position from a position of the valve member in the peripheral direction in the second closed position.
